(19) United States
(12) Patent Application Publication
(10) Pub. No.: US 2006/0009888 A1
(43) Pub. Date: Jan. 12, 2006

(54) DETERIORATION DETERMINATION SYSTEM FOR BATTERY FOR ELECTRIC VEHICLE

(76) Inventor: Takayuki Atsumi, Mori-machi (JP)

Correspondence Address: ERNEST A. BEUTLER, ATTORNEY AT LAW, 10 RUE MARSEILLE, NEWPORT BEACH, CA, 92660, US

(21) Appl. No.: 11/160,655

(22) Filed: Jul. 4, 2005

(30) Foreign Application Priority Data
Jul. 6, 2004 (JP) 2004-198749

(51) Int. Cl. G06F 17/00

(52) U.S. Cl. 701/22

(57) ABSTRACT

An electric motor driven battery powered vehicle and method for determining the battery condition therefore for replacement purposes wherein current flow through a coil of the motor is measured and internal resistance of the battery is determined by the current flow to avoid unnecessary replacement based only on time of usage.

### BACKGROUND OF THE INVENTION

The present invention relates to a deterioration determination system and method for determining a deterioration condition of a battery in an motor powered electric vehicle such as a golf cart that has the battery as an electric power source and is driven by a shunt winding type motor.

A wide variety of electric powered vehicles are driven by battery powered electric motors and particularly those of the shunt type. A typical example of such a vehicle is shown in Japanese Published Application JP-A-Hei10-309005. In such vehicles, the battery gradually deteriorates during repeated use because the battery is alternately discharged and charged. The deterioration of the battery results in a gradual increase of its internal resistance which gradually reduces its voltage and the battery cannot maintain a desired output. The performance of the electric vehicle thus deteriorates. For example, the acceleration of the vehicle will deteriorate even when an accelerator is fully depressed because of the inability of the motor to achieve maximum output.

Thus, the battery needs to be replaced by a new one before losing the desired output due to its deterioration. Conventionally, however, since there no system for determining the deteriorated condition of the battery, the practice has been to exchange the battery after a predetermined period of use.

However, the service conditions of the batteries differ from each other due to fact that the specific application are not uniform and because a discharge current amount of each battery fluctuates in response to an accelerator opening, and the battery voltage changes all the time together with the fluctuation as well as differences in operator demands. As a result, the deterioration rate of the batteries differ from each other in accordance with the differences of the service conditions and operator demands.

Thus, if the batteries are all exchanged at the same predetermined period, the exchange can be wasteful as some of the batteries have not deteriorated as to require replacement after the predetermined period. Also, some other batteries which are used under rigorous conditions can deteriorate before the predetermined period elapses, and thus may be used under a condition that the batteries cannot maintain sufficient output.

Therefore it is a principal object of the invention to provide a method and apparatus for accurately determining the state of deterioration of the battery of an electric motor powered vehicle that permits replacement to be made only when actually necessary.

### SUMMARY OF THE INVENTION

This invention is adapted to be embodied in an electric powered vehicle having a battery and a propulsion device driven by an electric motor powered by the battery. The electric motor is controlled by an ECU and has an armature coil and a field coil. A current sensor senses the current in at least one of the coils. A determination of the deterioration of the battery is made by determining the internal resistance of the battery based upon an amount detected by the current sensor.

Another feature of the invention is adapted to be embodied in a method for determining the condition of a battery for an electric powered vehicle having a battery and a propulsion device driven by an electric motor powered by the battery. The electric motor is controlled by an ECU and has an armature coil and a field coil. The method comprises the steps of sensing the current in at least one of the coils to determining the internal resistance of the battery based upon an amount detected by the current sensor.

### BRIEF DESCRIPTION OF THE DRAWINGS

FIG. 1 is a top plan view of an electric powered vehicle in the example of a golf cart constructed and operated in accordance with the invention.

FIG. 2 is a circuit block diagram embodying the invention.

FIG. 3 is a graph showing the deterioration characteristic of a battery.

FIG. 4 is a graph showing a current-voltage characteristic giving a reference for a deterioration determination map for the battery.

FIG. 5 is a block diagram showing a control method of the present invention.

FIG. 6 is a flowchart showing an execution process of the present invention.

### DETAILED DESCRIPTION

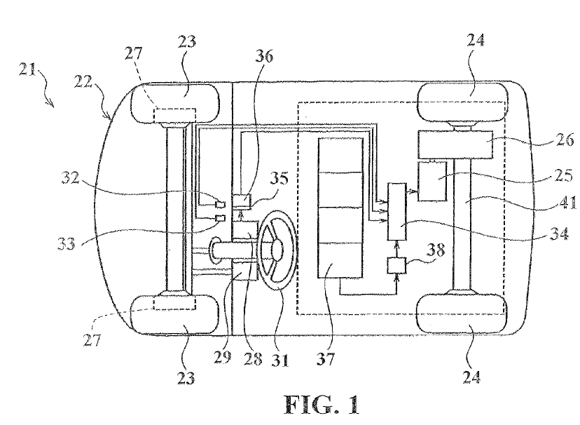

Referring now in detail to the drawings and initially to FIG. 1, an electrically powered vehicle such as a golf cart, as an example of vehicle with which the invention may be practiced is identified generally by the reference numeral 21. This golf cart 21 is provided with a body, frame 22 that rotatably supports in any desired manner paired front wheels 23 and rear wheels 24. In the illustrated embodiment, the rear wheels 24 are driven by a shunt type electric motor 25 through a transmission 26. Associated with some or all of the wheels 23 and 24 (only the front wheels 23 in the illustrated embodiment) are brakes 27 of any desired type.

An operator may be seated on a suitable seat (neither of which are shown) behind an accelerator pedal 28, for controlling the speed of the electric motor 25, a brake pedal 29, for operating the wheel brakes 27, and a steering wheel 31, for steering the front wheels 23 in any desired manner.

Also juxtaposed to the operator's position is a main switch 32, and a direction control switch 33, for controlling the direction of travel of the golf cart 21 by controlling the direction of rotation of the motor 25. The main switch 32 and the direction control switch 33 are connected to a controller 34. Operation of the accelerator pedal 28 is transmitted to an on off pedal switch 35 and an accelerator opening degree sensor 36 connected to the controller 34, to send on or off state of the accelerator 28 and its degree of opening to the controller 34.

A plurality of batteries 37 (48 V in total, for example) as power sources are mounted suitably on the body frame 22 and are connected through a relay 38 to the controller 34.

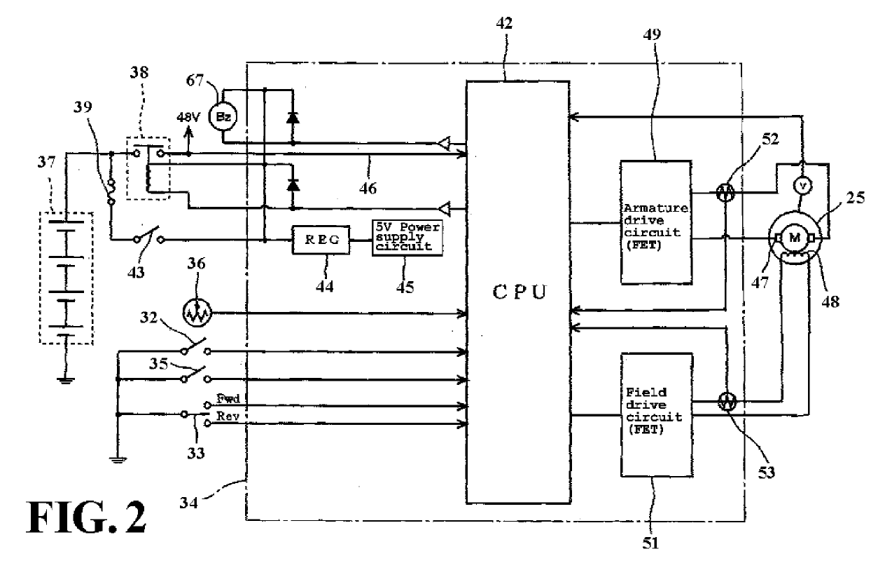

The electrical supply for the motor will now be described by reference to FIG. 2 which is a block circuit diagram of the golf cart 21 of FIG. 1. As will be seen, the source voltage for the motor 25 of shunt winding type that drives the golf cart 21 and for the controller 34 is supplied from the battery 37. The source voltage sent from the battery 37 is supplied to a CPU 42 that has a memory, a control circuit and so forth via the relay 38.

The source voltage of the battery 37 is supplied to the controller 34 via a fuse 39 and a control switch 43. The control switch 43 is used to stop the power supply to the controller 34 as the need arises, so as to stop an operation of an automatic brake circuit when, for example, a traction running or the like is made. The source voltage of 48V, for example, of the battery 37 is converted to 5V by a voltage lowering regulator 44 and a power supply circuit 45 in the controller 34, and is supplied to respective arithmetic circuits and drive circuits in the controller 34.

An analog amount of an actual voltage of the battery 37 is converted in the controller 34 to a digital amount of 0-5V which is suitable for arithmetic processing, and is inputted to the CPU 42 through a battery voltage AD input line 46 and via an interface (not shown). That is, the battery voltage is initially 48V; however, it goes down gradually or in response to its condition during its time and nature of use, depending on the use conditions and the deterioration condition of the battery 37. Thus, in order to make the arithmetic processing for the control based upon the battery voltage, an analog amount of, for example, 0-50V is converted to a digital amount of 0-5V and is inputted to the CPU 42.

Signals from the main switch 32, the pedal switch 35, the direction change switch 33, the accelerator opening sensor 36 and so forth are inputted to the CPU 42. The CPU 42 drives and controls the motor 25 based upon those signals.

As has been noted, the motor 25 of shunt winding type and has an armature coil 47 and a field coil 48 which are connected to an armature drive circuit 49 and a field drive circuit 51, respectively. Each of the armature drive circuit 49 and the field drive circuit 51 is formed with a plurality of FETs. Command currents calculated by an armature PWM arithmetic circuit and a field PWM arithmetic circuit (not shown) in the CPU 42 are impressed to the armature coil 47 and the field coil 48 via the armature drive circuit 49 and the field drive circuit 51, respectively.

An armature current (Ia) and a field current (If) are applied in accordance with commands given by PWM signals that indicate ratios of drive pulse widths. The field current is calculated based upon an Ia-If map which is previously programmed in accordance with a motor characteristic. This Ia-If map designates the field current amount at which the motor 25 is driven with the maximum efficiency relative to the armature current, and is stored in the memory (not shown) in the CPU.

Current sensors 52, 53 are disposed between the armature drive circuit 49 and the field drive circuit 51 and the armature coil 47 and the field coil 48 of the motor 53, respectively. Those sensors detect currents that actually flow through the armature coil 47 and the field coil 48. The command signals for driving the motor 25 and coming from the CPU 42 are feedback-controlled by those detected signals. Thereby, the currents flowing through the armature coil 47 and the field coil 48 of the motor 25 are accurately controlled, and cause the motor 25 generate the desired amount of torque corresponding to the amount of depression of the accelerator pedal 28.

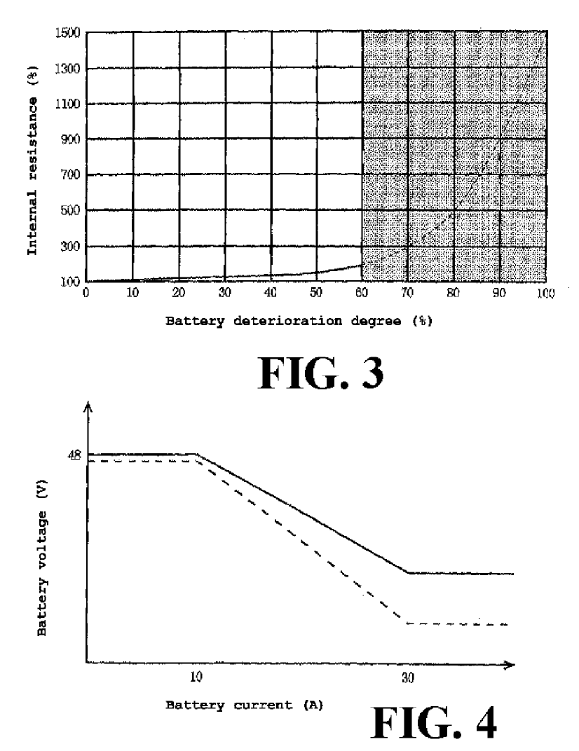

The manner of determining the state of deterioration of the battery 37 will now be described referring first to FIG. 3 which is a graph of battery characteristic that indicate the relationships between a deterioration degree and an increase rate (%) of internal resistance of the battery. As may be seen, the internal resistance of the battery 37 gradually increases with the degree of deterioration. The increase rate of each battery differs from one another.

In the example of FIG. 3, the internal resistance is approximately 200% of an initial amount when the deterioration degree of the battery reaches 60%, and the internal resistance rapidly increases afterwards. In connection with this type of battery, the deterioration of the battery is larger in the shaded range of FIG. 3 (the internal resistance is 200% or larger of the initial amount), and a suitable running performance of the electric vehicle cannot be obtained. Thus, the battery is preferably exchanged before the internal resistance becomes twice the initial amount.

FIG. 4 is a graph that indicates relationships between battery voltage and battery current under a discharge condition, showing that the current-voltage characteristic of the battery changes in response to the increase of the internal resistance associated with the battery deterioration. Additionally, the battery current under a running condition of the golf cart is normally 30 A or smaller. The voltage amount relative to the current amount falls because the internal resistance becomes larger with the deterioration of the battery. That is, the voltage goes down relative to the same current amount, and the entire graph moves downward. Such a current-voltage characteristic of the battery in response to the internal resistance can be determined beforehand. Thus, a map for determining the deterioration is prepared using the characteristic and is stored in the memory of the CPU.

Such a map can be prepared as a collective one formed with multiple maps that include, for example, 60% deterioration map, 70% deterioration map, 80% deterioration map and so forth. The CPU detects the battery current and the battery voltage, and can determine the deterioration degree of the battery from those amounts using the maps.

In this occasion, the battery voltage is a battery voltage inputted to the CPU, and thus can be obtained as data continuously. Also, the battery current can be calculated from the detected amount by the current sensor 52 of the armature coil 25 as described below when a shunt winding motor is used. Accordingly, the deterioration of the battery can be determined by detecting the current amount of the armature coil and based upon the detected data and the voltage data at that time using the map.

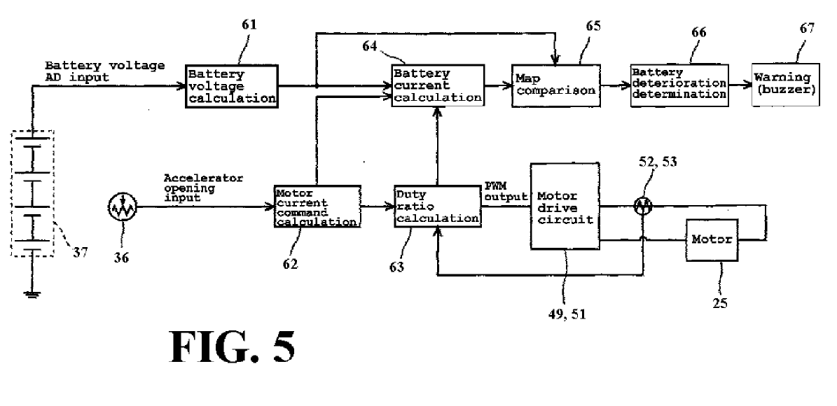

This will now be described by reference to FIG. 5 which is a block diagram that shows a control method in the controller 34. As described above in connection with FIG. 2, the battery voltage impressed at a voltage between 0-50V, for example, is converted into a digital amount of 0-5V in the controller 34 when inputted to the CPU 42. Thus, the voltage amount is reconverted to the analog amount from the digital amount to seek for the battery voltage in an arithmetic circuit 61, in order to determine the deterioration of the battery 37 using the internal resistance. That is, if digital data indicating 4V is inputted, the battery voltage is 40V, for example.

Also, when an accelerator opening is inputted to the controller 34 in the golf cart 21 described above, a command calculation of the motor current corresponding to the accelerator opening is conducted in an arithmetic circuit 62. Then, a duty ratio is calculated to realize the command current in an arithmetic circuit 63, and a preset current flows through the armature coil 47 and the field coil 48 of the motor 25 via the motor drive circuits 49, 51. Further, the current sensors 52, 53 are disposed between the motor drive circuits 49, 51 and the motor 25, so that current amounts that actually flow through the respective coils 47, 48 are detected. In order to determine the deterioration of the battery, data of the battery current are necessary.

The battery current can be calculated using the amounts of the motor current detected by the current sensors 52, 53 and the duty ratio is determined, as described below, in an arithmetic circuit 64.

When the battery voltage and the battery current are calculated as noted above, a point where the respective amounts intersect with each other is plotted in the map corresponding to the graph of FIG. 4 and is compared with a reference value in an arithmetic circuit 65. Thereby, whether the battery has deteriorated or not is determined in an arithmetic circuit 66. If the deterioration is determined, warning means 67 such as, for example, a buzzer, makes a warning.

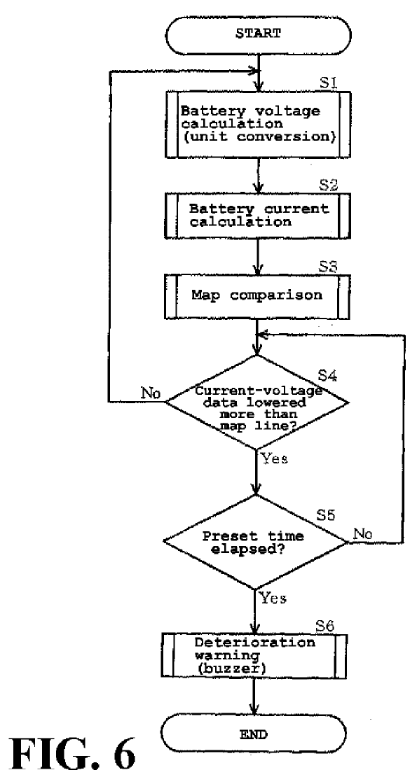

Referring now to FIG. 6 the execution process of the present invention conducted by the CPU 42 will be described. First, the battery voltage is converted from the digital amount to the initial analog amount at the step S1. This is the arithmetic processing to seek for the actual battery voltage conducted by the arithmetic circuit 61 of FIG. 5 as described above.

Next, the arithmetic circuit 64 (FIG. 5) calculates the battery current amount Ib based upon the motor current amounts detected by the current sensors 52, 53 and the duty ratio using the following equation (S2):
Ib=Ia*Da*η+If*Df*η
where
   Ia: motor current (armature side) (A)
   Da: duty ratio (armature side)
   η: efficiency
   If: motor current (field side) (A)
   Df: duty ratio (field side).

In this regard, the motor current Ia detected data of the current flowing through the armature coil 47 detected by the current sensor 52 (FIG. 2). Also, the motor current If is detected data of the current flowing through the field coil 48 detected by the current sensor 53.

The drive current of the field coil is preset such that the motor is driven with the maximum efficiency relative to the drive current of the armature coil, and the current to the field coil is controlled to be consistent with the drive current. That is, when Ia is decided, It is determined in the one-on-one relationships with the Ia. The battery current Ib described above thus can be calculated only with the detected data of Ia.

When the calculation of the battery voltage and the battery current under the discharge condition is completed through the steps described above, the point where the respective amounts of the battery current and the battery voltage intersect with each other is plotted in the graph of FIG. 4 (deterioration determination map) and is compared with the reference value at the step S3.

Then, it is determined whether the point is positioned in a deterioration range which exists below a line of the map which is indicated by a dotted line and defines a determination reference line, i.e., whether the internal resistance exceeds the reference amount due to the progress of the deterioration at the step S4. If the point is positioned above the determination reference line, it is determined that the deterioration has not occurred and the battery is continuously used as it is.

If, however at the step S4 it is determined that the battery has deteriorated, it is further determined whether the preset period or longer has elapsed after the current-voltage data exceeded the determination reference amount at the step S5. This is to avoid erroneous deterioration determination when, for example, the point is momentarily plotted in the deterioration range due to a slight time lag in the detection of the voltage and the current or in the calculation thereof, an influence by disturbance or the like occurs, or the like. Thereby, the reliability of the determination is enhanced.

If the condition that the current-voltage data is positioned below the map line, i.e., that the deterioration is considered to occur, continues for the preset period or longer, it is determined that the battery has deteriorated, the buzzer sounds the warning at the step S6. Additionally, the warning means can be a lamp lightning, a display on a display device and so forth, other than the buzzer.

In the embodiment described above, the deterioration is determined using the graphical map of the current-voltage characteristic of the battery. However, the deterioration also can be determined by calculating an internal resistance (R) with the battery current (I) and the voltage (V) (basic equation: R=V/I), and by determining whether the internal resistance exceeds a predetermined threshold amount. Also, multiple maps corresponding to deterioration degrees may be prepared to determine the current deterioration degree and display that the determined deterioration is equal to what percentage of the normal condition. Of course those skilled in the art will readily understand that the described embodiments are only exemplary of forms that the invention may take and that various changes and modifications may be made without departing from the spirit and scope of the invention, as defined by the appended claims.

What is claimed is:

1. An electric powered vehicle having a battery and a propulsion device driven by an electric motor powered by said battery, said electric motor being controlled by an ECU and having an armature coil and a field coil, a current sensor, a system for determining the deterioration of said battery by determining the internal resistance of said battery based upon an amount detected by said current sensor.

2. An electric powered vehicle as set forth in claim 1 wherein further including a deterioration determination map reflecting the internal resistance of the battery based upon a current-voltage characteristic of the battery, and determining the deterioration of the battery using said map based upon the detected amount by the current sensor.

3. An electric powered vehicle as set forth in claim 2 in calculating a battery current Ib from the detected amount by the current sensor by the following equation: Ib=Ia*Da*η+If*Df*η, where Ia: motor current (armature side), Da: duty ratio (armature side), η: efficiency, If: motor current (field side) and Df: duty ratio (field side), and determining the deterioration of the battery using the map based upon the battery current Ib.

4. An electric powered vehicle as set forth in claim 2 wherein it is determined that the battery has deteriorated when a deterioration condition according to the map continues for a preset period or longer.

5. An electric powered vehicle as set forth in claim 1 further including warning device for warning a user that the battery has deteriorated when the deterioration has been determined.

6. A method for determining deterioration of the powering battery of electric powered vehicle having propulsion device driven by an electric motor powered by the battery, the electric motor being controlled by an ECU and having an armature coil and a field coil, sensing the current flow through at least one of said coils, determining the deterioration of said battery by determining the internal resistance of the battery based upon the detected current amount.

7. The method as set forth in claim 6 wherein further including the step of forming a deterioration determination map reflecting the internal resistance of the battery based upon a current-voltage characteristic of the battery, and determining the deterioration of the battery using said map.

8. The method as set forth in claim 7 further including the step of calculating a battery current Ib from the detected current amount by the following equation:
Ib=Ia*Da*η+If*Df*η
where
Ia: motor current (armature side)
Da: duty ratio (armature side)
η: efficiency
If: motor current (field side) and
Df: duty ratio (field side),
and determining the deterioration of the battery using the map based upon the battery current Ib.

9. The method as set forth in claim 7 wherein it is determined that the battery has deteriorated when a deterioration condition according to the map continues for a preset period or longer.

10. The method as set forth in claim 6 further including further including the step of warning a user that the battery has deteriorated when the deterioration has been determined.
